(19) United States
(12) Patent Application Publication
(10) Pub. No.: US 2012/0305651 A1
(43) Pub. Date: Dec. 6, 2012

(54) ELECTROCHEMICAL CAPACITOR BATTERY HYBRID ENERGY STORAGE DEVICE CAPABLE OF SELF-RECHARGING

(75) Inventors: Marc A. Anderson, Madison, WI (US); Kevin C. Leonard, Madison, WI (US)

(73) Assignee: WISCONSIN ALUMNI RESEARCH FOUNDATION, Madison, WI (US)

(21) Appl. No.: 13/149,276

(22) Filed: May 31, 2011

(51) Int. Cl. G06K 19/077; H01M 14/00; H01M 4/02; H01M 4/62; B82Y 30/00

(52) U.S. Cl. 235/492; 429/7; 977/780

(57) ABSTRACT

An electrochemical device includes an anode, a cathode, and an electrically conductive material between the anode and the cathode coated with a nanoporous oxide coating. Gaps or spaces are filled with an electrolyte. The electrochemical device may be used to power an electronic card.

### STATEMENT REGARDING FEDERALLY SPONSORED RESEARCH OR DEVELOPMENT

This invention was made with government support under grant number N00014-03-1-0647 awarded by the Department of Defense Office of Naval Research and grant number DMR-0441575 awarded by the National Science Foundation. The government has certain rights in the invention.

### FIELD OF THE DISCLOSURE

The present disclosure generally relates to electrochemical devices. More particularly, embodiments of the present disclosure relate to self-charging electrochemical storage and delivery devices and applications for such devices including electronic cards such as Radio Frequency Identification (RFID) cards and garage door opener transponders.

### BACKGROUND OF THE DISCLOSURE

Galvanic cells, more commonly called batteries, are a type of electrochemical device that convert stored chemical energy to electrical energy. Batteries are typically divided into two broad classes, primary and secondary. Primary batteries such as alkaline batteries convert stored chemical energy to electrical energy by oxidation and reduction reactions which result in geochemically unfavorable restructuring and depletion of chemical reactants (e.g., manganese dioxide in the case of an alkaline battery). When the initial supply of chemical reactants is exhausted in a primary battery, the battery cannot be readily recharged.

Secondary batteries such as lithium-ion batteries also convert stored chemical energy to electrical energy. Converting stored chemical energy to electrical energy in secondary batteries does not involve an unfavorable geochemical restructuring. Secondary batteries can be readily recharged by applying electrical energy to the battery which reverses the chemical reactions, restoring the stored chemical energy in the battery. Secondary batteries are growing in popularity and, with the increasing number of handheld devices, their application space is increasing. Two major drawbacks of existing secondary batteries are their need for an external energy source when recharging and the low energy yield in comparison to the energy used to charge them.

Electrochemical capacitors (also known as ultracapacitors or supercapacitors) are energy storage devices that have higher specific power and longer cycle lives than batteries. This improvement in power density and cycle life is possible because electrochemical capacitors store energy within the electrochemical double layer at the electrode/electrolyte interface as opposed to storing energy with battery-type faradaic oxidation-reduction reactions. While ultracapacitors or supercapacitors have grown in popularity due to their efficiency, improvements in stored energy and in specific power or power density over existing batteries and ultracapacitors are desirable. Particularly, there is a need for an electrochemical device that is self-charging that can further provide an open circuit potential similar to conventional batteries.

### SUMMARY OF THE DISCLOSURE

The present disclosure is generally directed to a self-charging electrochemical device having electrodes (e.g., anode and cathode) including an electrically conductive material between the electrodes that is coated with a nanoporous oxide. It has now been found that by incorporating an electrically conductive material coated with a nanoporous oxide between an anode and a cathode, creating a single combination electrochemical device, a self-charging electrochemical device is produced.

In one aspect, the present disclosure is directed to an electrochemical device including an anode, a cathode, an electrolyte, and an electrically conductive material coated with a nanoporous oxide. The electrolyte separates the anode from the cathode, and the electrically conductive material is between the anode and the cathode. In one embodiment, the electrochemical device further includes a nonconductive separator between the anode and the cathode, and the nonconductive separator is separated from the anode and the cathode by the electrolyte.

In another aspect, the present disclosure is directed to an electrochemical device including an anode, a cathode, and an electrolyte separating the anode from the cathode. At least one of the anode and the cathode is substantially coated with an electrically conductive material coated with a nanoporous oxide.

In another aspect, the present disclosure is directed to an electronic card such as a Radio Frequency Identification (RFID) card or garage door opener transponder. The electronic card includes an electrochemical device and a memory storing data. The memory at least intermittently receives power from the electrochemical device. In one embodiment, the electronic card further includes a display for displaying the data stored in the memory and receiving power from the electrochemical device. In another embodiment, the electronic card further includes a transmitter for transmitting at least a portion of the data stored in the memory.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 is a cross section of an electrochemical device showing layers of the electrochemical device according to a vertical embodiment of the electrochemical device disclosed herein.

FIG. 2 is a top view of an electrochemical device according to a horizontal embodiment of the electrochemical device disclosed herein.

FIG. 3 is a block diagram of an electronic card comprising a horizontal embodiment of the electrochemical device disclosed herein.

FIG. 4 is a graph of voltage versus time for a vertical embodiment of the electrochemical device disclosed herein and a standard galvanic cell battery each discharged at a constant current.

FIG. 5 is a graph of voltage versus time for a vertical embodiment of the electrochemical device disclosed herein, wherein the electrochemical device is pulsed at a constant current.

FIG. 6 is a graph of voltage versus time for a vertical embodiment of the electrochemical device disclosed herein wherein the device is discharged at a constant current for a predetermined period of time.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein may be used in the practice or testing of the present disclosure, suitable methods and materials are described below.

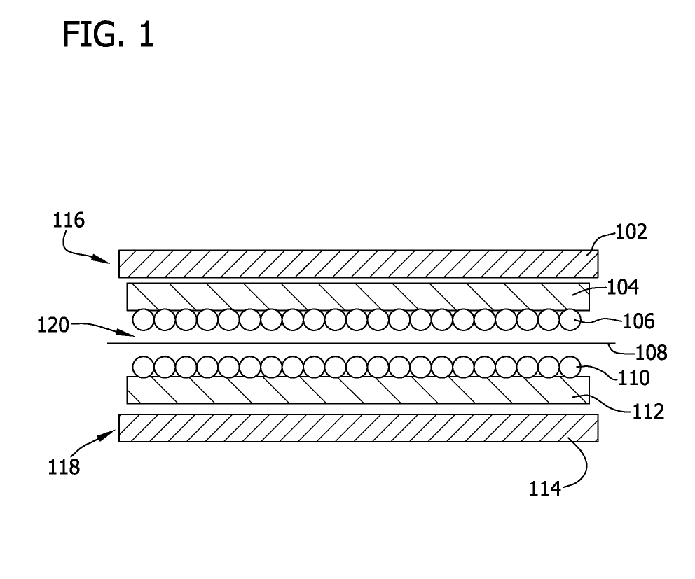

Referring to FIG. 1, a cross section shows the layers of a vertical embodiment of the electrochemical device of the present disclosure. A first electrode 116 of the electrochemical device comprises a cathode 102 coated with a first layer of electrically conductive material 104. A first layer of nanoporous oxide 106 is coated onto the first layer of electrically conductive material 104. A nonconductive separator 108 separates the first electrode 116 from a second electrode 118 of the electrochemical device. The second electrode 118 comprises an anode 114 coated with a second layer of electrically conductive material 112. The second layer of electrically conductive material 112 is coated with a second layer of nanoporous oxide 110. An electrolyte fills any gaps 120 or spaces between layers.

In one particularly preferred embodiment, the cathode 102 is copper, the anode 114 is aluminum, nickel, or zinc; the first and second layers of electrically conductive material 104 and 112, respectively, are electrically conducting carbon; the electrolyte is sodium sulfate or potassium chloride; and the first and second layers of nanoporous oxide 106 and 110, respectively, are silicon dioxide. It should be contemplated; however, that any other suitable conducting materials know in the electrochemical device art may be used as the cathode and the anode 102 and 114, respectively, as described more fully below.

It is further contemplated that the first and second layers of electrically conductive material 104 and 112, respectively, may be coated onto respectively the cathode 102 and anode 114 in one embodiment and separate from the cathode 102 and anode 114 in another embodiment. In one embodiment, there is only one layer of electrically conductive material between the cathode 102 and the anode 114, and the layer of electrically conductive material may be coated on either the cathode 102 or the anode 114 or separate from both the cathode 102 and anode 114.

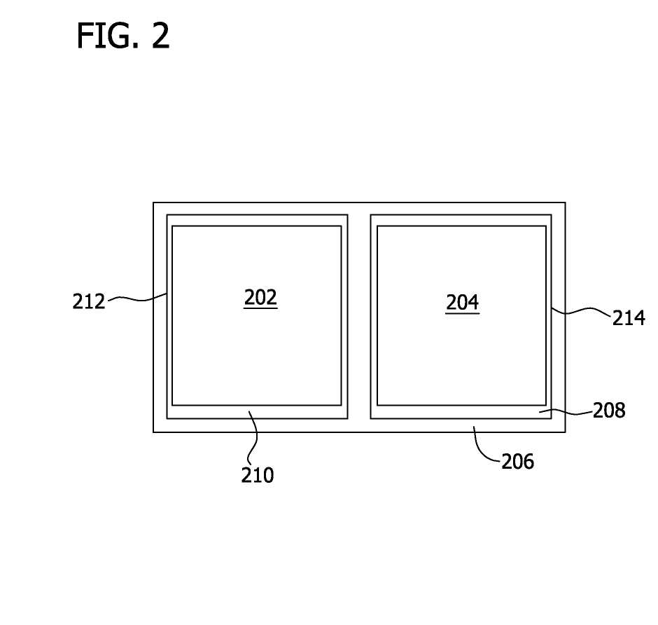

Referring to FIG. 2, a horizontal embodiment of the electrochemical device disclosed herein includes a first electrode 212 and a second electrode 214 disposed on a substrate 206. In one embodiment, the substrate 206 further includes a nonconductive separator and electrolyte (not shown). The electrolyte wicks through the nonconductive separator to the first electrode 212 and second electrode 214. The first electrode 212 comprises a cathode 202 coated with a first layer of electrically conductive material 210. The second electrode 214 comprises an anode 204 coated with a second layer of electrically conductive material 208. In alternative embodiments, the first layer of electrically conductive material 210 and the second layer of electrically conductive material 208 are separate from one or both of the cathode 202 and the anode 204. In one embodiment, the first and second layers of electrically conductive material 210 and 208, respectively, are coated with nanoporous oxide.

In one particularly preferred embodiment, the cathode 202 is copper; the anode 204 is aluminum, nickel, or zinc; the first and second layers of electrically conductive material 210 and 208, respectively, are electrically conducting carbon; the electrolyte is sodium sulfate or potassium chloride; and the nonporous oxide coating is silicon dioxide. In one embodiment, there is only one layer of electrically conductive material electrically separating the cathode 202 and the anode 204, and the layer of electrically conductive material may be a coating on either the cathode 202 or anode 204 or separate from the cathode 202 and anode 204.

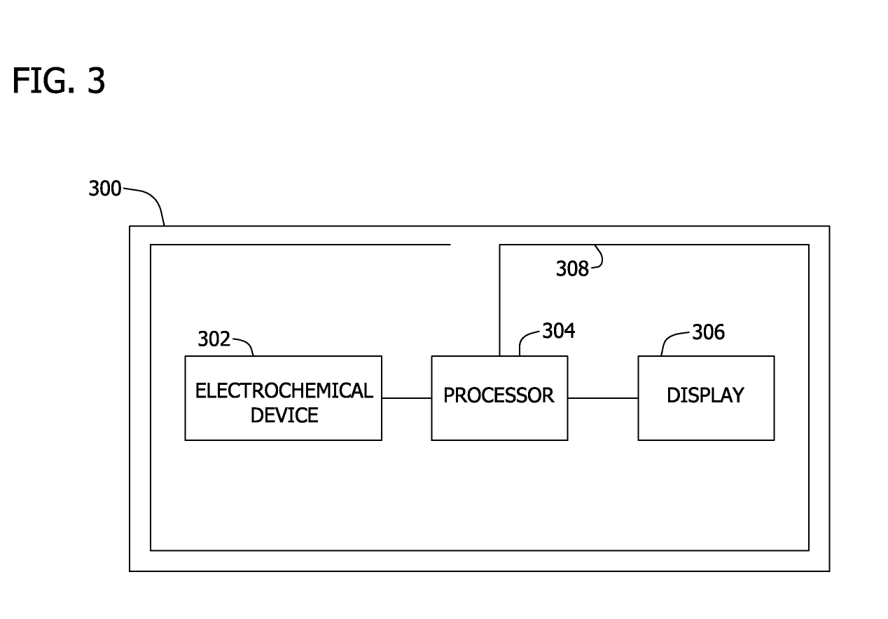

Referring to FIG. 3, an electronic card 300 includes an electrochemical device 302, a processor 304, a display 306, and an antenna 308. In one embodiment, the processor 304 receives a wake signal via the antennal 308 and wakes up. The processor 304 then reads data from a memory of the processor 304 and provides power from the electrochemical device 302 and the data from the memory to the display 306 for display to a user. In another embodiment, the processor 304 includes a transmitter and transmits the read data via the antenna 308 while the display 306 is optional. Optionally, the processor 304 may perform some operation on the read data and send modified data to the display 306 or transmit the modified data via antenna 308. This embodiment may be used as, for example, an RFID card or smart credit/debit card.

In another embodiment, the electronic card 300 wakes the processer 304 in response to receiving input from a user (e.g., a user presses a button on the electronic card 300). The processor 304 wakes, reads data from a memory of the processor 304, and transmits the read data via the antenna 308. This embodiment may be used as, for example, a garage door opener transponder, in which the display 306 may be optionally included. Optionally, the processor 304 may perform some operation on the read data and transmit modified data via the antenna 308 such as in a rolling code garage door opener system.

### Materials of the Electrochemical Device

Electrolyte

Electrolyte is an aqueous solution including an organic or inorganic acid, an organic or inorganic base, or an organic or inorganic salt. Suitable aqueous solutions may include an electrolyte-forming substance including electrolytes resulting from phosphoric acid, potassium chloride, sodium perchlorate, sodium chloride, lithium chloride, lithium nitrate, potassium nitrate, sodium nitrate, sodium hydroxide, potassium hydroxide, lithium hydroxide, ammonium hydroxide, ammonium chloride, ammonium nitrate, lithium perchlorate, calcium chloride, magnesium chloride, hydrochloric acid, nitric acid, sulfuric acid, potassium perchlorate, sodium phosphate, disodium hydrogen phosphate, monosodium phosphate, and combinations thereof.

Electrodes

The first and second electrodes (i.e., the anode and the cathode) include suitable conducting materials such as known in the art to be used in electrochemical devices including any primary (non-rechargeable) or secondary (rechargeable) battery chemistries. The anodes and cathodes could be comprised of any materials exhibiting oxidation/reduction couple reactions where the difference in standard electrode potential is greater than approximately 0.1 V. Some examples include copper and zinc, alkaline battery chemistries such as MnO₂ and Zinc, and Li-Ion Battery Chemistries including LiMnO₂ or LiCoO₂ with Li metal or graphite, and Metal Air Batteries including the zinc air battery. The voltage of the battery charges the capacitor, and the electrolyte used should be compatible with both the battery and capacitor materials (e.g., an electrically conductive layer and/or a nanoporous oxide layer).

At least one of the anode and cathode may further be coated with an electrically conductive material such as conducting carbon, conducting metals, conducting polymers, and combinations thereof. In another embodiment, the anode and/or cathode are coated with electrically conductive materials that are mixtures of conducting carbon materials, conducting metals, and conducting polymers. Suitable mixtures may be, for example, carbon-metal, carbon-polymer, metal-polymer, and carbon-metal-polymer mixtures. Additional mixtures may be, for example, mixtures of porous and nonporous carbon, porous and nonporous metals, and porous and nonporous polymers and combinations thereof.

Conducting Carbon

In one embodiment, the conductive material is a conducting carbon. The conductivity of the conducting carbon may be from about 10⁻⁶ S/m to about 10⁷ S/m or more. Conducting carbon may be obtained from commercial suppliers such as Calgon Carbon, Carbon Chem, Shell Carbon, Hollingsworth and Vose. Both non-porous and porous conducting carbons as known in the art are suitable for use as the electrically conductive materials. For example, activated carbon, single-wall carbon nanotubes, multi-wall carbon nanotubes, and graphene may be suitable conducting carbons.

Suitable porous carbon may have a surface area of from about 1 m²/g to about 2000 m²/g. More suitably, the surface area of the porous carbon may be from about 30 m²/g to about 1500 m²/g.

In yet other embodiment, a mixture of carbon may be used as the conducting carbon for coating one or both of the anode and cathode of the electrochemical device. For example, a higher surface area porous carbon may be mixed with a higher conductivity carbon such as graphite, acetylene black or graphene.

Conducting Metals

The first and second electrodes (i.e., cathode and anode) may be coated with any conducting metal known in the art, as well as combinations of conducting metals. Suitable conducting metals may be, for example, titanium, stainless steel, aluminum, iron, nickel, platinum, gold, palladium, silver, and combinations thereof. Particularly suitable conducting metals may be non-precious metals such as, for example, titanium, stainless steel, aluminum, nickel, iron, and combinations thereof. Both porous and non-porous conducting metals may be used as the electrically conductive materials. Porous conducting metals may be obtained from commercial suppliers such as Mott Corporation.

Conducting Polymers

In another embodiment, the first and second electrodes (i.e., the anode and cathode) are coated with conducting polymers. The term “conducting polymers” is used according to its ordinary meaning as understood by those skilled in the art to refer to organic polymers that conduct electricity. Suitable polymers may be, for example, polyaniline, polypyrrole, polythiophenes, polyethylenedioxythiophene, poly(p-phenylene vinylene)s, and combinations thereof. In some embodiments, the conducting polymers may be doped using an oxidation-reduction process such as, for example, by chemically doping and electrochemical doping, as understood by those skilled in the art.

Nanoporous Oxide Coating

In one embodiment, nanoparticles are applied to, and suitably, created on, the electrically conductive material between the electrodes (i.e., anode and the cathode) in the form of a nanoporous oxide coating. Suitable nanoporous oxides for use in the coating may be, for example, silicon dioxide (SiO₂), zirconium oxide (also referred to as zirconium dioxide and ZrO₂), titanium oxide (TiO₂), aluminum oxide (Al₂O₃), manganese oxide (MnO, Mn₃O₄, Mn₂O₃, MnO₂, Mn₂O₇), magnesium oxide (MgO), zinc oxide (ZnO), tin oxide (SnO), lead oxide (PbO), iron oxide (Fe₂O₃), and combinations thereof. Suitable oxides may be those wherein the other atom in the oxide is selected from beryllium, manganese, magnesium, calcium, strontium, barium, radium, titanium, zirconium, hafnium, zinc, cadmium, mercury, boron, aluminum, gallium, indium, thallium, carbon, silicon, germanium, tin, lead, and combinations thereof.

In one embodiment, the nanoporous oxide coating may be doped with metals. The terms “doped” and “doping” are used interchangeably herein according to their ordinary meanings as understood by those skilled in the art to refer to the addition of metal materials to the nanoporous oxide coating. Suitable metals that may be used to dope the nanoporous oxide coating may be, for example, titanium, aluminum, nickel, iron, tungsten, platinum, gold, palladium, silver, and combinations thereof. Suitable amounts of metal used to dope the nanoporous oxide coating may be, for example, up to about 5% by weight. In one embodiment, the nanoporous oxide coating is doped with about 0.1% by weight to about 5% by weight metal.

The nanoporous oxide coating may be porous or nonporous. Suitable average pore diameter size of the nanoporous oxide coating may be from about 0.01 nm to about 500 nm. A particularly suitable average pore size diameter may be from about 0.3 nm to about 25 nm. The porosity of the nanoporous oxide coating can be controlled according to the methods and conditions used to apply the coating as described herein. The nanoporous oxide coating may be applied to the electrically conductive material by any suitable method known by those skilled in the art. Suitable application methods may include, for example, chemical vapor deposition, dip-coating, electrodeposition, imbibing, plasma spray-coating, spin coating, sputter-coating, slip casting, spray-coating, and combinations thereof.

The nanoporous oxide coating is typically prepared using sol-gel chemistry methods. Typically, the sol-gel suspension is made by adding a metal alkoxide with water in either acidic or basic conditions. The metal alkoxide then undergoes hydrolysis and condensation reactions, which form the oxide nanoparticles. The suspension, including the nanoporous oxide nanoparticles, is then applied to the electrically conductive material by contacting the suspension to the electrically conductive material according to any method such as, for example, chemical vapor deposition, sputtering, plasma spray, spray coating, spin coating, dip coating, slip casting, imbibing, electrodeposition, and combinations thereof. If desired, application of the nanoporous oxide may be applied using scintering (firing) temperatures from about 100° C. to 1500° C. Particularly suitable firing temperatures may be from about 300° C. to about 500° C. Even more suitable firing temperatures may be from about 350° C. to about 450° C.

The conditions in which the nanoporous oxide coating is applied may be adjusted by those skilled in the art to achieve a desired coating characteristic. Such coating characteristics may include, for example, porosity of the coating, thickness of the coating, number of coatings (also referred to herein as layers), and combinations thereof. Conditions that may be adjusted may include, for example, temperature, particle size of the nanoporous oxide in suspension, concentration of the suspension, pH of the suspension, and combinations thereof.

The amount of nanoporous oxide coating applied to the electrically conductive material depends on the nanoporous oxide coating to be applied and the type of electrically conductive material used with the electrodes. Suitable amounts may be, for example, from about 1% by weight to about 50% by weight. Particularly suitable amounts may be, for example, from about 1% by weight to about 40% by weight. Even more suitable amounts may be, for example, from about 1% by weight to about 30% by weight. Even more suitable amounts may be, for example, from about 1% by weight to about 25% by weight.

Any number of nanoporous oxide coating layers may be applied to the electrically conductive material. As used herein, the terms “coats”, “coatings”, and “layers” are used interchangeably. A suitable number of nanoporous oxide coating layers may be, for example, one or more. A particularly suitable number of nanoporous oxide coating layers may be from 1 to 5 layers. The number of the nanoporous oxide coating layers can be controlled according to the methods and conditions used to apply the coatings and the conditions described herein. It should be understood that the nanoporous oxide coating may partially and/or completely coat the conducting material; however, completely coating the electrically conductive material is desirable.

A nanoporous oxide coating layer may be of any thickness known as suitable by those skilled in the art. A particularly suitable thickness may be from about 0.01 μm to about 50 μm. An even more suitable thickness may be from about 0.1 μm to about 10 μm. The thickness of the nanoporous oxide coating layer may be controlled according to the methods and conditions used to apply the coating layer as described herein. In some embodiments, the thicknesses of individual nanoporous oxide coating layers may be varied such that different layers of the nanoporous oxide coating may have different thicknesses.

The electrochemical device of the present disclosure provides for a unique energy storage system and energy delivery system such that the device behaves as both a battery and an ultracapacitor. More particularly, the electrochemical device of the present disclosure is self-charging such that it does not need an external source for charging and can self-charge repeatedly such as to achieve a long, unattended operation. The electrochemical device of the present disclosure combines battery electrodes and electrochemical capacitor electrodes. By placing the electrochemical capacitor electrodes between the anode and cathode of the battery, the potential drop (i.e. voltage) that is created by the battery electrodes is able to charge the capacitor electrodes by separating the anions and cations in the electrolyte. Because the capacitor electrodes naturally have higher power densities and faster discharge rates than the battery electrodes, the capacitor electrodes will discharge first when a load is placed on the device. After the capacitor electrodes are discharged and the device is allowed to equilibrate to open circuit conditions, the battery electrodes then recharge the capacitor electrodes, which act as a self-charging energy storage system. Within the device, the battery is attempting to recharge the capacitor at all times, but during discharge under adequate current the discharge of the capacitor may exceed the recharge rate of the battery, resulting in discharge of the battery (i.e., discharges the entire device such that an external charging source may become advantageous). The electrochemical devices of the present disclosure can also be recharged externally. When secondary battery chemistries are used the entire device can also be recharged externally as done with many secondary batteries (e.g. Li-Ion batteries).

The electrochemical devices of the present disclosure may suitably be used in various electrochemical applications. For example, the electrochemical devices may be used in electronic cards, and particularly, in Radio Frequency Identification (RFID) cards and garage door opener transponders.

Embodiments of the invention may be better understood by reference to the following non-limiting examples.

### EXAMPLES

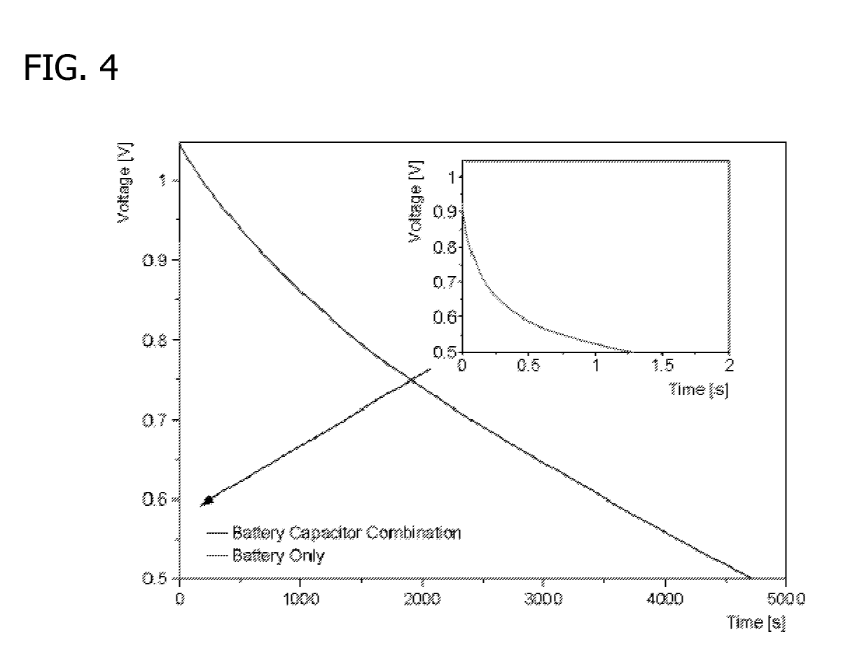

Table 1 shows the performance of a standard copper cathode and zinc anode battery in a sodium sulfate electrolyte versus the performance of an electrochemical device of the present disclosure comprising a combination battery and ultracapacitor as described herein. The combination electrochemical device is a vertical embodiment (see, e.g., FIG. 1) comprising the standard battery components, but the electrodes are additionally comprised of an activated carbon cloth coated with silica nanoparticles. The standard battery and combination electrochemical device of the present disclosure were each discharged at the same constant current, and their voltages were monitored. When discharged at 0.1 milliamp, the combination electrochemical device took 4509.44 seconds to decrease to 0.5 volts while the standard battery decreased to 0.5 volts in 1.76 seconds. FIG. 4 plots voltage versus time for each of the standard battery and combination electrochemical device when discharged at 0.1 milliamp. The energy difference between the standard battery and the combination electrochemical device is more than 3 orders of magnitude.

TABLE 1
Discharge rates and energy content.

| | 1 mA | | 0.1 mA | | 0.01 mA | |
|---|---|---|---|---|---|---|
| | Discharge | Energy | Discharge | Energy | Discharge | Energy |
| | Time (s) | (mJ) | Time (s) | (mJ) | Time (s) | (mJ) |
| Combi- | 304.34 | 304.34 | 4509.44 | 450.94 | 24106.0 | 241.06 |
| nation | | | | | | |
| Battery | 0.03 | 0.03 | 1.76 | 0.18 | 25.6 | 0.26 |
| Only | | | | | | |

The open circuit voltage for a standard galvanic single cell battery is about 0.9 volts. When the ultracapacitor is placed in parallel with the battery, the open circuit voltage drops to about 0.2 volts. The reason for the voltage drop is that the ultracapacitor has a higher energy density than the battery. Thus, when placed in parallel the battery needs to charge the ultracapacitor until equilibrium is reached. The battery voltage thus decreases from 0.9 volts to 0.2 volts while the ultracapacitor voltage increases from 0 volts to 0.2 volts. Alternatively, when the battery and ultracapacitor are connected in series, the open circuit voltage is about 0.85 volts. When an ultracapacitor is manufactured between the anode and cathode of the battery in a single electrochemical device such as according to the present disclosure, there is almost no change in the open circuit voltage (i.e., the open circuit voltage is about 0.85 volts), which is an unexpected result as even though the ultracapacitor must be charged, there is much less impact on the battery.

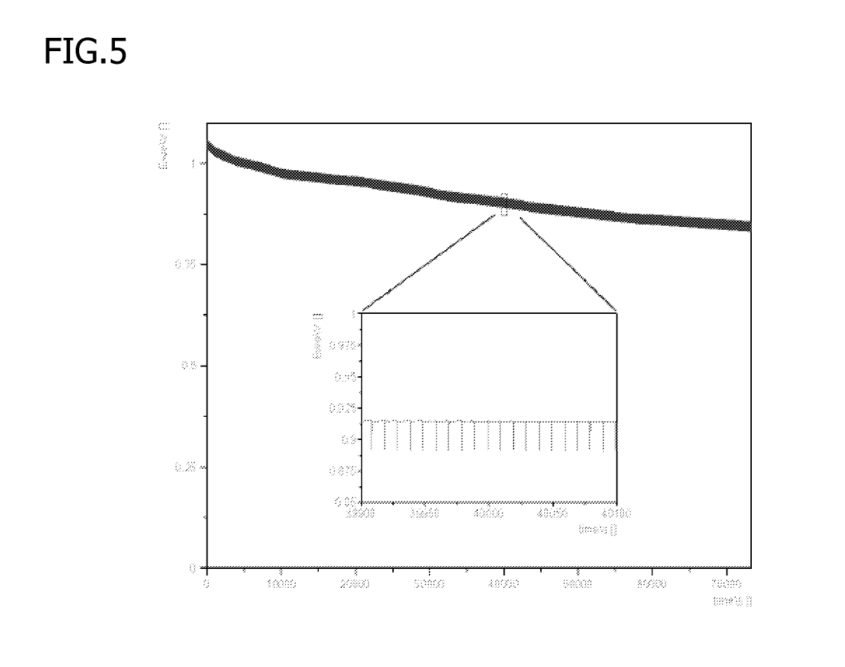

Referring to FIG. 5, a graph of voltage versus time is shown for a vertical embodiment of the electrochemical device disclosed herein (see, e.g., FIG. 1) wherein the device is pulsed at a constant current. The electrochemical device tested for FIG. 5 includes a copper cathode and zinc anode, each with a carbon nanofoam layer coated with silica nanoparticles. The combination device was pulsed at 5 mA for 50 ms with 10 seconds rest between pulses. This load would be similar to that seen in an electronic card application.

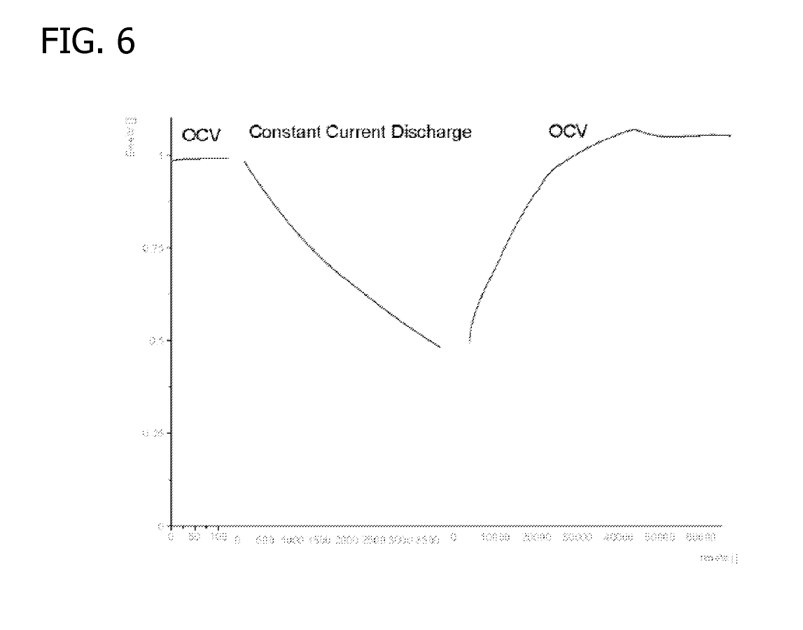

Referring to FIG. 6, a graph of voltage versus time is shown for a vertical embodiment of the electrochemical device disclosed herein wherein the device is discharged at a constant current and monitored thereafter. The electrochemical device comprises a copper cathode and zinc anode, each with a carbon nanofoam outer layer coated with silica nanoparticles. The time axis of the graph resets several times. In the earliest portion, the open circuit voltage of the device is steady at about 0.85 volts. The device is then discharged for about 4000 seconds at 0.1 milliamp to 0.5 volts. Thereafter, the open circuit voltage of the device is monitored and seen to rise back to 0.85 volts over the next 50,000 to 60,000 seconds. The device thus exhibits an unexpected self-charging phenomena.

What is claimed is:

1. An electrochemical device comprising:
an anode;
a cathode;
an electrolyte separating the anode from the cathode; and
an electrically conductive material between the anode and the cathode, wherein the electrically conductive material is coated with a nanoporous oxide.

2. The electrochemical device of claim 1, further comprising a nonconductive separator between the anode and cathode, wherein said nonconductive separator is separated from the anode and the cathode by the electrolyte.

3. The electrochemical device of claim 1, wherein the electrically conductive material is selected from the group consisting of a porous carbon, a nonporous carbon, a porous metal, a nonporous metal, a porous polymer, a nonporous polymer, and combinations thereof.

4. The electrochemical device of claim 3, wherein the porous metal or the nonporous metal is selected from the group consisting of titanium, aluminum, nickel, stainless steel, iron, and combinations thereof.

5. The electrochemical device of claim 3, wherein the porous polymer or the nonporous polymer is selected from the group consisting of polyaniline, polypyrrole, polythiophenes, polyethylenedioxythiophene, poly(p-phenylene vinylene)s, and combinations thereof.

6. The electrochemical device of claim 1, wherein the nanoporous oxide is selected from the group consisting of silicon dioxide, zirconium oxide, titanium oxide, aluminum oxide, manganese oxide, magnesium oxide, magnesium aluminum oxide, tin oxide, lead oxide, iron oxide, and combinations thereof.

7. The electrochemical device of claim 1, wherein the electrically conductive material is coated with one to five nanoporous oxide layers.

8. An electrochemical device comprising:
an anode;
a cathode; and
an electrolyte separating the anode from the cathode, wherein at least one of the anode and the cathode is coated with an electrically conductive material, and wherein the electrically conductive material is coated with a nanoporous oxide.

9. The electrochemical device of claim 8, wherein both the anode and the cathode are coated with the electrically conductive material.

10. The electrochemical device of claim 8, further comprising a nonconductive separator between the anode and cathode, wherein said nonconductive separator is separated from the anode and the cathode by electrolyte.

11. The electrochemical device of claim 8, wherein the electrically conductive material is selected from the group consisting of a porous carbon, a nonporous carbon, a porous metal, a nonporous metal, a porous polymer, a nonporous polymer, and combinations thereof.

12. The electrochemical device of claim 11, wherein the porous metal or the nonporous metal is selected from the group consisting of titanium, aluminum, nickel, stainless steel, iron, and combinations thereof.

13. The electrochemical device of claim 11, wherein the porous polymer or the nonporous polymer is selected from the group consisting of polyaniline, polypyrrole, polythiophenes, polyethylenedioxythiophene, poly(p-phenylene vinylene)s, and combinations thereof.

14. The electrochemical device of claim 8, wherein the nanoporous oxide is selected from the group consisting of silicon dioxide, zirconium oxide, titanium oxide, aluminum oxide, manganese oxide, magnesium oxide, magnesium aluminum oxide, tin oxide, lead oxide, iron oxide, and combinations thereof.

15. An electronic card comprising:
an electrochemical device comprising:
an anode;
a cathode;
an electrolyte separating the anode from the cathode; and
an electrically conductive material between the anode and the cathode, wherein the electrically conductive material is coated with a nanoporous oxide; and
a memory storing data, said memory at least intermittently receiving power from the electrochemical device.

16. The electronic card of claim 15, wherein the electrically conductive material is selected from the group consisting of a porous carbon, a nonporous carbon, a porous metal, a nonporous metal, a porous polymer, a nonporous polymer, and combinations thereof.

17. The electronic card of claim 15, wherein the electrically conductive material is coated with one to five nanoporous oxide layers.

18. The electronic card of claim 15, wherein both the anode and the cathode are coated with the electrically conductive material.

19. The electronic card of claim 15, further comprising a display for displaying the data stored in the memory, said display at least intermittently receiving power from the electrochemical device.

20. The electronic card of claim 15, further comprising a transmitter for transmitting at least a portion of the data stored in the memory, said transmitter at least intermittently receiving power from the electrochemical device.
